(19) United States
(12) Patent Application Publication
(10) Pub. No.: US 2002/0193088 A1
(43) Pub. Date: Dec. 19, 2002

(54) Frequency matching method and apparatus for mobile systems

(75) Inventor: Sang-Il Jung, Anyang (KR)

Correspondence Address: JONATHAN Y. KANG, ESQ,, LEE & HONG P.C., 11th Floor, 221 N. Figueroa Street, Los Angeles, CA, 90012-2801, US

(73) Assignee: LG Electronics Inc.

(21) Appl. No.: 10/164,274

(22) Filed: Jun. 5, 2002

(30) Foreign Application Priority Data
Jun. 19, 2001 (KR) 34683/2001

(51) Int. Cl. H04B 1/18

(52) U.S. Cl. 455/191.2; 455/191.1; 455/188.1

(57) ABSTRACT

Frequency matching method and apparatus to automatically adjust the frequency of a communication signal received by a mobile system are provided. The apparatus comprises: a baseband unit for changing frequency of a signal received through an antenna and providing an output signal; a control unit for recognizing one or more frequency characteristics of the output signal and applying a control voltage in accordance with the respective frequency characteristics; a matching unit connected to the antenna for changing the signal frequency according to the control voltage; and a memory in which control voltage values for the respective frequency characteristics are stored. Accordingly, signal gain is optimized in correspondence with the respective frequency characteristics and thereby signal reception and transmission are improved.

### CROSS REFERENCE TO RELATED APPLICATION

This application claims the benefit of Korean Patent Application No. 2001-34683, filed on Jun. 19, 2001, which is hereby incorporated by reference in its entirety.

### BACKGROUND OF THE INVENTION

1. Field of the Invention

The present invention relates to a frequency matching method and apparatus for a mobile system, and particularly, to a frequency matching method and apparatus for recognizing one or more characteristics of a received signal and for automatically adjusting the signal to an appropriate frequency to improve signal gain, reception and transmission.

2. Description of the Related Art

Generally, a property of a portable device such as a wireless telephone or a mobile system is changed according to a distance between the antenna and the user, the size, or the location where the antenna is used. In addition, since signal gain varies according to the channel frequency recognized by the antenna, a frequency matching procedure is employed in order to optimize the gain.

FIG. 1 is a block diagram illustrating a frequency matching apparatus for a mobile system according to conventional art. As shown, the frequency matching apparatus comprises: a matching unit 2 for matching a radio signal received through an antenna 1 and generating an output signal; a baseband unit 5 for receiving a radio signal through a receiver/transmitter unit 4 and changing the frequency of the signal; a control unit 6 for processing a signal provided by the baseband unit 5; and a memory 7 for storing data and programs which are needed to operate the control unit 6.

FIG. 2 is a block diagram illustrating a matching unit 2 according to the conventional art. The matching unit 2 comprises: an inductor L1 formed between the antenna 1 and a duplexer 3 for receiving a signal from antenna 1 and generating an output; and a capacitor C1 having one end connected between the inductor L1 and a connecting portion of the antenna 1. The other end of the capacitor C1 is grounded.

The operation of the conventional frequency matching apparatus of FIG. 1 is provided below. An input signal received by antenna 1 is provided to the matching unit 2. The matching unit 2 matches the signal and generates an output signal. This output signal is then provided to the baseband unit 5 through the receiver/transmitter unit 4. The baseband unit 5 changes the frequency of the signal and provides it to the control unit 6. The control unit 6 receives the signal from the baseband unit 5 and uses the frequency band and channel of the signal to apply a control signal to the capacitor C1 in the matching unit 12. Capacitor C1 has a fixed capacitance and therefore the matching unit 2 adjusts the signal at a constant value regardless of the frequency property of the signal received.

FIG. 3 is a graph illustrating the antenna resonant frequency of the conventional art apparatus of FIG. 1. The capacitor has a fixed capacitance and the frequency is matched at a constant value. Therefore, the capacitor resonates at only one frequency (f₀), thereby reducing a voltage standing wave ratio (VSWR). The voltage standing wave ratio (VSWR) represents a standing wave ratio (SWR) that represents a degree of mismatching using numbers, as the standing wave voltage waveform, if an impedance mismatch is generated. The degree of mismatching is recognized using the voltage standing wave ratio (VSWR) and thereby a transmission loss generated during mismatching may be controlled.

Accordingly, in the above-described conventional art apparatus, the following events take place: an optimal match is generated by the matching unit 2, maximum power is supplied to a load, the transmission loss and the voltage standing wave ratio (VSWR) are reduced, and thereby the gain is increased. The conventional frequency matching apparatus has a fixed capacitance and is optimized for a certain frequency only. Therefore, the frequency gain cannot be changed according to the input frequency. In addition, if the apparatus has higher gain for the frequency of a certain band, the gain for the other frequencies cannot be relatively optimized.

Further, in the conventional art frequency matching apparatus, if various channel frequencies are received, the gain cannot be optimized for each of the respective frequencies. Therefore, a constant gain would not be maintained.

### SUMMARY OF THE INVENTION

Frequency matching method and apparatus to automatically control the frequency of a communication signal received by an antenna in a mobile system are provided. The apparatus comprises: a baseband unit for changing frequency of a signal received through the antenna and providing an output signal; a control unit for recognizing one or more frequency characteristics of the output signal and providing a control voltage in accordance with the respective frequency characteristics; a matching unit connected to the antenna for changing signal frequency according to the control voltage; and a memory in which control voltage values for the respective frequency characteristics are stored. Accordingly, signal gain is optimized in accordance with the respective frequency characteristics and thereby signal reception and transmission are improved.

In one embodiment, the matching unit comprises a varactor diode, the capacitance of which may be adjusted by adjusting the control voltage. The control voltage can be adjusted to maintain an optimal matching state in accordance with changes in frequency characteristics of the signal received by the antenna.

The features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

It is to be understood, however, that both the above summary and the following detailed description are exemplary and explanatory and are intended to provide further explanation of the invention as claimed and as such shall not be construed to limit the scope of the invention in any manner.

### BRIEF DESCRIPTION OF THE DRAWINGS

The accompanying drawings, which are included to provide a further understanding of the invention, are incorporated in and constitute a part of this specification.

FIG. 1 is a block diagram showing a frequency matching apparatus for a mobile system according to the conventional art;

FIG. 2 is a circuit diagram showing a matching unit according to the conventional art;

FIG. 3 is a graph showing a resonant frequency for the frequency matching apparatus of FIG. 1;

FIG. 4 is a block diagram showing a frequency matching apparatus for a mobile system according to one embodiment of the invention;

FIG. 5 is a circuit diagram showing a matching unit according to one embodiment of the invention;

FIG. 6 is a graph showing a characteristic of a varactor diode in accordance with one embodiment of the invention; and

FIG. 7 is a graph showing a resonant frequency of the frequency matching apparatus according to one embodiment of the invention.

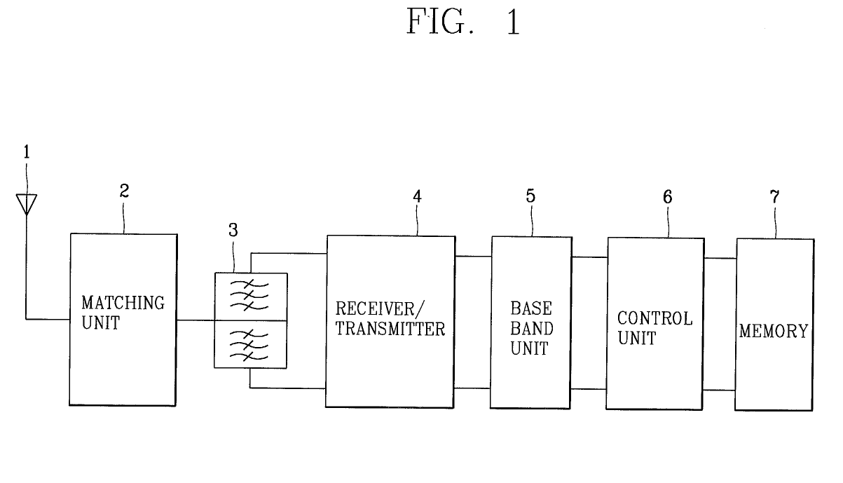

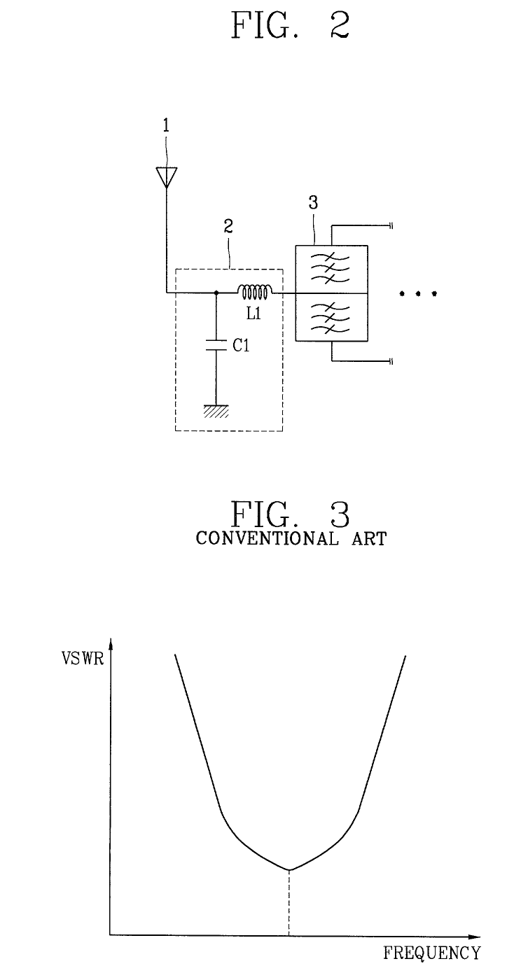

Features, elements, and aspects of the invention that are referenced by the same numerals in different figures represent the same, equivalent, or similar features, elements, or aspects in accordance with one or more embodiments.

### DETAILED DESCRIPTION OF THE PREFERRED EMBODIMENTS

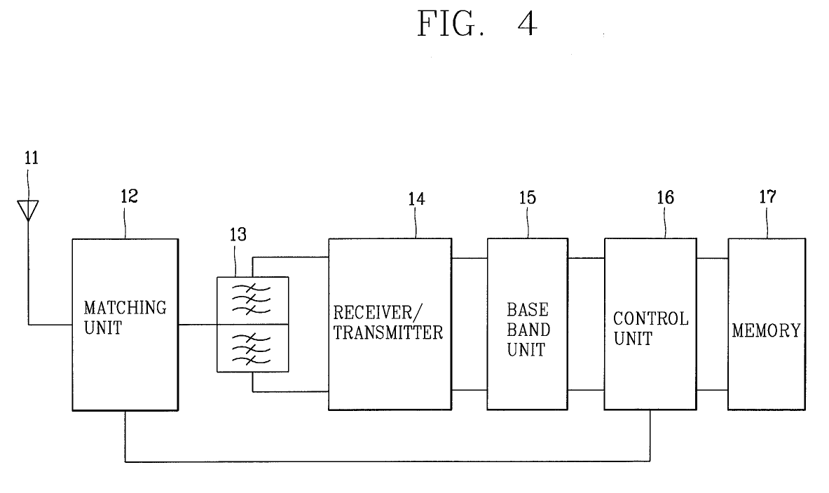

Referring to FIG. 4, the frequency matching apparatus for a mobile system in accordance with one or more embodiments of the invention comprises: an antenna 11 for receiving a radio signal from a base station (not shown); a matching unit 12 for changing the signal frequency in accordance with a control signal; a baseband unit 15 for adjusting the signal frequency of the received radio signal from the antenna 11 and providing an output signal; a control unit 16 for receiving the output signal and recognizing one or more of its frequency characteristics and generating the control signal utilized by the matching unit 12.

In one embodiment of the invention, the control unit 16 recognizes the baseband and channel characteristics of the radio signal received through the antenna 11 and applies a control voltage for the corresponding characteristics to the matching unit 12 to optimize signal gain. The control unit 16 is connected to the baseband unit 15, the matching unit 12 and the memory 17, respectively, as illustrated in FIG. 4, for example.

Information about a plurality of control voltages for the frequency baseband and the channel characteristics of the radio signal is stored in the memory 17, for example. In one embodiment, said information is stored in a look-up table in the memory 17 so that each signal characteristic is associated with a corresponding control voltage value. The control unit 16 selects a control voltage value from among the values of plurality of control voltages stored in the memory 17 and applies the respective control voltage to the matching unit 12.

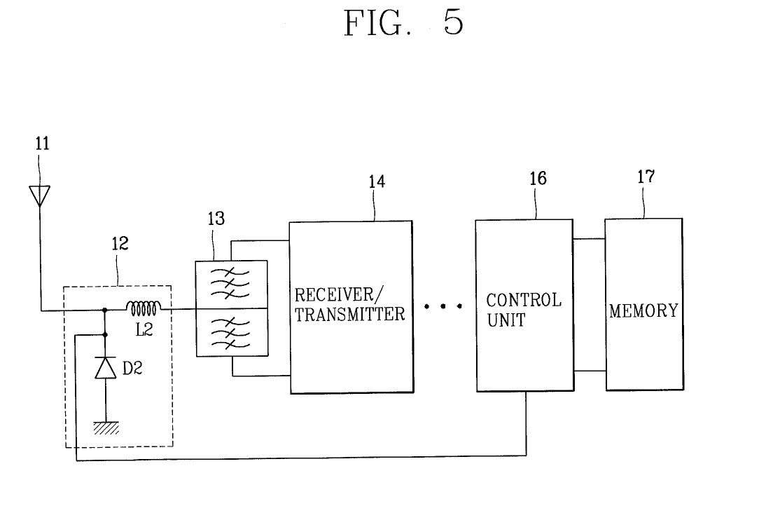

Referring to FIG. 5, the matching unit 12 comprises a varactor diode D2, and an inductor L2 formed between the antenna 11 and a duplexer 13. The duplexer 13 provides the signal received through the antenna to a receiver/transmitter unit 14 and the varactor diode D2. One side of the varactor diode D2 is connected between the inductor L2 and the antenna 11 and the other end is grounded. The capacitance of the varactor diode D2 is adjusted based on the control voltage of the control unit 16.

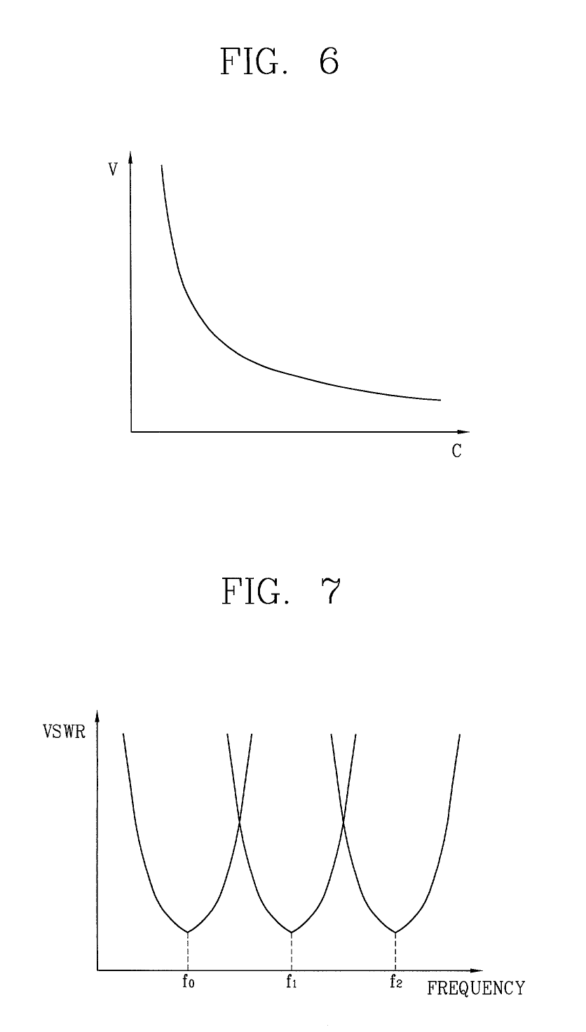

Referring to FIG. 6, when the control voltage applied by the control unit 16 is increased, the capacitance of the varactor diode D2 is decreased. The capacitance of the varactor diode D2 changes according to the control voltages applied by the control unit 16, to optimize signal gain. The control unit 16 applies the control voltage to the matching unit 12 after recognizing the frequency characteristic of the signal received by the antenna 11 and changes the control voltage based on the frequency characteristics of the received signal. As such, the varactor diode D2 has different capacitance values according to the various frequencies.

Referring to FIG. 7, the varactor diode D2 can have a plurality of resonant frequencies by virtue of controlling the capacitance in accordance with the recognized frequency characteristics. The matching unit 12 optimizes signal gain in correspondence with the frequency characteristics of the input signal and is able to improve signal reception in a mobile system and reduce transmission output.

Referring back to FIGS. 4 and 5, the operation of the frequency matching apparatus for the mobile system according to one or more embodiments of the present invention is provided below. The signal of a mobile communication base station (not shown) transmitted to the antenna 11 resonates in the matching unit 12, passes through the duplexer 13 and the receiver/transmitter unit 14, respectively, and is thereafter provided to the baseband unit 15 which in turn generates an output signal.

The output signal from the baseband unit 15 is applied to the control unit 16 which determines the frequency band and the channel characteristics of the received signal and applies a voltage corresponding to said frequency characteristics of the signal to the matching unit 12. The control unit 16 extracts the control voltage value corresponding to the received frequency characteristic from the memory 17 where the appropriate control voltages associated with the frequency characteristics are stored. The control voltage is then applied to the varactor diode D2 of the matching unit 12.

The varactor diode D2 of the matching unit 12 receives the control voltage from the control unit 16 and reduces the capacitance D2 when the control voltage increases, and increases the capacitance D2 when the control voltage decreases to optimize the signal gain in correspondence with the band and channel of the frequency of the signal received.

Accordingly, the frequency matching apparatus of the present invention is able to change the capacitance of the matching unit 12 in correspondence with the various frequency bands and channels recognized for a received signal. As such, signal gain can be optimized for various frequencies, and thereby, signal reception and transmission can be optimized.

Although particular embodiments of the invention have been shown and described, it will be apparent to those skilled in the art that changes and modifications may be made without departing from the invention in its broader aspects, and therefore, the appended claims are to encompass within their scope all such changes and modifications that fall within the true scope of the invention.

What is claimed is:

1. A frequency matching apparatus for a mobile system comprising:
a baseband unit for changing a frequency of a signal received through an antenna;
a control unit for recognizing a frequency characteristic of the signal and providing a control voltage for the respective frequency characteristic;
a matching unit connected to the antenna for changing the signal frequency according to the control voltage; and
a memory for storing one or more control voltage values for one or more frequency characteristics.

2. The apparatus of claim 1, wherein the matching unit comprises:
an inductor connected to the antenna; and
a varactor diode having a first end connected to the inductor and a second end grounded, wherein the capacitance is adjusted by changes in the control voltage.

3. The apparatus of claim 2, wherein the varactor diode reduces the capacitance when the control voltage is increased.

4. The apparatus of claim 1, wherein the control unit extracts from the memory a control voltage value corresponding with the recognized frequency characteristic of the signal and applies the respective voltage to the matching unit.

5. The apparatus of claim 1, wherein the one or more frequency characteristics include information about bands and channels of the signal.

6. A frequency matching apparatus comprising:
a matching unit including an inductor and a varactor diode;
a memory in which one or more control voltage values are stored; and
a control unit for extracting a control voltage value stored in the memory and applying a control voltage equal to the extracted value to the matching unit.

7. A frequency matching apparatus comprising:
a baseband unit for receiving a first signal via an antenna and generating a second signal;
a control unit for receiving the second signal, determining one or more frequency characteristics of the second signal and providing a control voltage corresponding to at least one of said frequency characteristics; and
a matching unit for receiving the control voltage and improving signal gain, reception and transmission, wherein the control voltage is adjusted based on said one or more frequency characteristics.

8. The apparatus of claim 7, further comprising:
a duplexer and a receiver/transmitter unit positioned between the antenna and the baseband unit through which the first signal passes before it is received by the baseband unit.

9. The apparatus of claim 7, further comprising:
a memory for storing information about the one or more frequency characteristics and one or more corresponding voltage values matching with the respective frequency characteristics.

10. The apparatus of claim 7, wherein the one or more frequency characteristics comprise information about the frequency band and the channel of the second signal.

11. The apparatus of claim 7, wherein the matching unit comprises:
a varactor diode for receiving the control voltage; and
an inductor formed between the antenna and the duplexer,
wherein the duplexer provides the first signal received through the antenna to the receiver/transmitter unit and the varactor diode.

12. The apparatus of claim 11, wherein one side of the varactor diode is connected between the inductor and the antenna, and the other end is grounded.

13. The apparatus of claim 11, wherein the capacitance of the varactor diode changes based on changes in the control voltage.

14. The apparatus of claim 11, wherein when the control voltage increases the capacitance of the varactor diode decreases.

15. The apparatus of claim 11, wherein when the control voltage decreases the capacitance of the varactor diode increases.

16. The apparatus of claim 11, wherein the change in the capacitance of the varactor diode results in optimization of signal gain, reception and transmission.

17. A frequency matching method in a mobile system comprising:
recognizing one or more frequency characteristics of a signal; and
changing a capacitance in correspondence with said one or more frequency characteristics to improve signal gain, reception and transmission.

18. The method of claim 17, wherein a varactor diode is utilized to change the capacitance in accordance to an applied voltage that corresponds with said one or more frequency characteristics.

19. A frequency matching method for controlling signal gain in a mobile system comprising:
recognizing a frequency characteristic of a radio signal received through an antenna; and
selecting from memory a control voltage associated with the recognized frequency characteristic.

20. The method of claim 19, wherein the control voltage is applied to a varactor diode so that a capacitance can be adjusted in correspondence with the frequency characteristic.

21. A frequency matching method comprising:
receiving a signal via an antenna;
recognizing one or more frequency characteristics of the signal;
determining a control voltage corresponding to at least one of said frequency characteristics; and
applying the control voltage to a matching unit for improving signal gain, reception and transmission, wherein the control voltage is adjusted based on change in said one or more frequency characteristics.

22. The method of claim 21, further comprising:
storing information about the one or more frequency characteristics and one or more corresponding voltage values in memory.

23. The method of claim 21, wherein the one or more frequency characteristics comprise information about the frequency band and the channel of the signal.

24. The method of claim 21, wherein the matching unit comprises a varactor diode for receiving the control voltage.

25. The method of claim 24 wherein the capacitance of the varactor diode changes based on changes in the control voltage.

26. The method of claim 25, wherein when the control voltage increases the capacitance of the varactor diode decreases.

27. The method of claim 25, wherein when the control voltage decreases the capacitance of the varactor diode increases.

28. The method of claim 24, wherein the change in the capacitance of the varactor diode results in optimization of signal gain, reception and transmission.

29. The method of claim 22, wherein the information about the one or more frequency characteristics and the one or more corresponding voltage values is stored in a look-up table in the memory.

30. A method of matching the frequency of a radio signal received by a mobile communication system, the method comprising:
receiving a signal via an antenna;
recognizing one or more frequency characteristics of the signal;
selecting a control voltage value, corresponding to at least one recognized frequency characteristic, from among one or more control voltage values; and
applying a control voltage equal to the first control voltage value to a varactor diode to adjust the capacitance of the varactor diode such that the signal gain, reception and transmission of the mobile communication system is improved.
